(19) United States
(12) Patent Application Publication
(10) Pub. No.: US 2017/0365827 A1
(43) Pub. Date: Dec. 21, 2017

(54) BATTERY SYSTEM

(71) Applicant: SANYO Electric Co., Ltd., Osaka (JP)

(72) Inventors: WATARU OKADA, Hyogo (JP); YOSHIHIRO SHIOTSU, Osaka (JP); TOMOMI TANAKA, Hyogo (JP); SEIJI KUMAZAWA, Osaka (JP)

(21) Appl. No.: 15/541,484

(22) PCT Filed: Dec. 9, 2015
(86) PCT No.: PCT/JP2015/006130

§ 371 Date: Jul. 5, 2017

(30) Foreign Application Priority Data
Mar. 31, 2015 (JP) 2015-073508

(51) Int. Cl. H01M 2/10; H01M 2/14; H01M 2/20; H01M 2/26

(52) U.S. Cl. CPC H01M 2/1077; H01M 2/26; H01M 2/14; H01M 2/206; H01M 2220/20

(57) ABSTRACT

A battery system includes a plurality of battery cells; a busbar that is laser-welded to electrode terminals of the adjacent battery cells and electrically connects the battery cells; and a plastic insulating wall disposed between the adjacent electrode terminals. The surface color of the insulating wall is a heat-ray reflecting color having far-infrared reflectance of 50% or more.

### TECHNICAL FIELD

The present invention relates to a battery system including a plurality of battery cells connected in series or in parallel via a busbar, and in particular to a battery system in which a busbar is connected to electrode terminals of battery cells by laser welding.

### BACKGROUND ART

In a battery system, a plurality of battery cells can be connected in series to increase an output voltage and in parallel to increase charging and discharging current. For example, a large-current and high-output battery system used as a power source for a motor that drives a vehicle has a plurality of battery cells connected in series to increase an output voltage. In a battery system to be used in this application, a plurality of battery cells is connected by a busbar made of a metal plate. The busbar is connected to electrode terminals of the battery cells constituting the battery system by laser-welding or screwing. The connection structure in which the busbar is connected to the electrode terminals by welding has a feature that the busbar can be stably connected to the electrode terminals for a long time without applying an excessive rotation torque to the electrode terminals. In particular, a connection structure in which the busbar is weld-joined by irradiation with a laser beam has a feature that stable connection can be carried out. In the battery system having this connection structure, the busbar is irradiated with a laser beam and weld-joined to the electrode terminals (see Patent Literature 1).

### CITATION LIST

### Patent Literature

PTL 1: Japanese Patent Application Unexamined Publication No. 2011-60623

### SUMMARY OF THE INVENTION

### Technical Problem

In a battery system in which a plurality of battery cells are connected by using busbars, a potential difference is generated between adjacent busbars. In order to improve insulating property between the busbars having a potential difference, it is important that the battery system secures a sufficient creepage distance between the adjacent busbars. In order to secure an insulating distance, specifically, the creepage distance and spatial distance are considered. The spatial distance corresponds to a linear distance between conductors insulated from each other. The creepage distance corresponds to a distance measured along a surface of an insulated product that separates the conductors from each other. The insulating distance between the busbars can be secured by providing an insulating wall between the busbars.

Incidentally, in the battery system in which the busbars are laser-welded to the electrode terminals, in a manufacturing step, a laser beam with which the busbars are irradiated melts the busbars and scatters spatters to the surrounding. A problem of scattering of spatters can be prevented by the insulating wall provided between the busbars. However, in the step of irradiating the busbar with a laser beam, an insulating wall made of plastic absorbs thermal energy from the surrounding, is heated, melted, and further vaporized so as to generate a large amount of gas. The gas generated in this step inhibits weld-joining of the busbar. The vaporized plastic gas enters the weld-joined portion of the busbar and the electrode terminal, thus inhibiting reliable weld-joining.

A problem that the insulating wall generates gas and inhibits laser-welding can be solved by forming an insulating wall of a material such as ceramic having excellent heat resistance. However, a ceramic insulating wall has various problems that, for example, the component cost is high, it is difficult to form the ceramic insulating wall into an ideal shape at high accuracy because it is produced by firing, and, furthermore, the ceramic insulating wall is heavy, thus increasing a manufacturing cost, and the like.

The present invention has been developed for the purpose of solving such problems. An important object of the present invention is to provide a battery system in which a busbar can be stably laser-welded to the electrode terminals while a creepage distance is secured using an insulating wall made of insulating plastic that can be mass-produced at a low cost.

### Solution to Problem and Advantageous Effects of the Present Invention

The battery system of the present invention includes a plurality of battery cells 1, busbar 3 that is laser-welded to electrode terminals 2 of adjacent battery cells 1 and electrically connects battery cells 1, and insulating wall 19 made of plastic disposed between the adjacent electrode terminals 2. Insulating wall 19 has a surface color that is a heat-ray reflecting color having far-infrared reflectance of 50% or more.

The above-mentioned battery system has a feature that the busbar can be stably laser-welded to the electrode terminals using an insulating wall made of insulating plastic that can be mass-produced at a low cost, while a creepage distance between the electrode terminals having a potential difference is secured and insulating property is secured. In a conventional battery system in which a busbar is laser-welded to electrode terminals, in a step of laser-welding the busbar to the electrode terminals, the busbar is irradiated with a laser beam and heated. Therefore, the insulating wall absorbs heat rays and is melted, and furthermore, the surface is vaporized to generate a large amount of gas. The generated gas enters the melting portion of the busbar and the electrode terminals to thus inhibit laser welding.

In the battery system of the present invention, a surface of the insulating wall has a heat-ray reflecting color. Therefore, in a step of heating the busbar with a laser beam, the surface of the insulating wall can reflect heat-rays efficiently. Accordingly, while the laser beam heats and weld-joins the busbar, the insulating wall made of plastic can be prevented from being heated and generating gas. Therefore, failure in weld-joining of the busbar due to the gas generated by the heated insulating wall can be prevented, so that the busbar can be weld-joined to the electrode terminals reliably and stably. In particular, since the above-mentioned battery system prevents the insulating wall from absorbing heat and inhibits generation of gas, it is not necessary to form an insulating wall using material such as ceramic having excellent heat resistance. Thus, the busbar can be laser-welded to electrode terminals reliably and stably using the insulating wall made of plastic that can be mass produced at a low cost and processed into an ideal shape with high dimensional accuracy.

In the battery system of the present invention, insulating wall 19 can be formed of a resin having a heat-ray reflecting color.

In this battery system, since an insulating wall is formed of a resin having the heat-ray reflecting color, surface treatment such as coating is not required after the insulating wall is molded, and the insulating wall can be mass-produced at a low cost.

In the battery system of the present invention, insulating wall 19 can include a filler having a heat-ray reflecting color.

This battery system has a feature that the insulating wall has a surface having a heat-ray reflecting color and can reduce absorption of thermal energy regardless of material property or a body color of plastic to be molded into the insulating wall.

In the battery system of the present invention, a surface of insulating wall 19 can be coated with a coating material that reflects at least one of visible light and infrared rays.

In the battery system of the present invention, battery cells 1 are rectangular batteries, and plastic insulating separator 18 stacked between the rectangular batteries is formed unitarily with insulating wall 19.

In this battery system, since the insulating wall is unitarily formed with the insulating separator sandwiched between the rectangular batteries, the insulating wall can be positioned in an ideal position, and a creepage distance between the adjacent busbars can be secured. Furthermore, a structure for disposing the insulating wall to a predetermined position is not required, thus making it possible to simplify the attachment structure of the insulating wall.

In the battery system of the present invention, insulating wall 19 can be unitarily formed with plastic busbar holder 20 for disposing busbars 3.

In this battery system, since an insulating wall is unitarily formed with a busbar holder that disposes the busbar to the predetermined position, the adjacent busbars can be insulated from each other in a state in which the relative position between the insulating wall and the busbar is allowed to be in an ideal state. Furthermore, a structure for disposing the insulating wall to a predetermined position is not required, thus making it possible to simplify the attachment structure of the insulating wall.

### BRIEF DESCRIPTION OF THE DRAWINGS

FIG. 1 is a perspective view of a battery system in accordance with one exemplary embodiment.

FIG. 2 is a vertical sectional view of the battery system shown in FIG. 1.

FIG. 3 is a schematic perspective view showing a link structure between battery cells and busbars of the battery system shown in FIG. 1.

FIG. 4 is an exploded perspective view showing the link structure between the battery cells and the busbars of the battery system shown in FIG. 3.

FIG. 5 is a schematic enlarged sectional view showing the link structure between an electrode terminal of a battery cell and a busbar.

FIG. 6 is an enlarged plan view showing another example of a busbar.

FIG. 7 is an enlarged plan view showing still another example of a busbar.

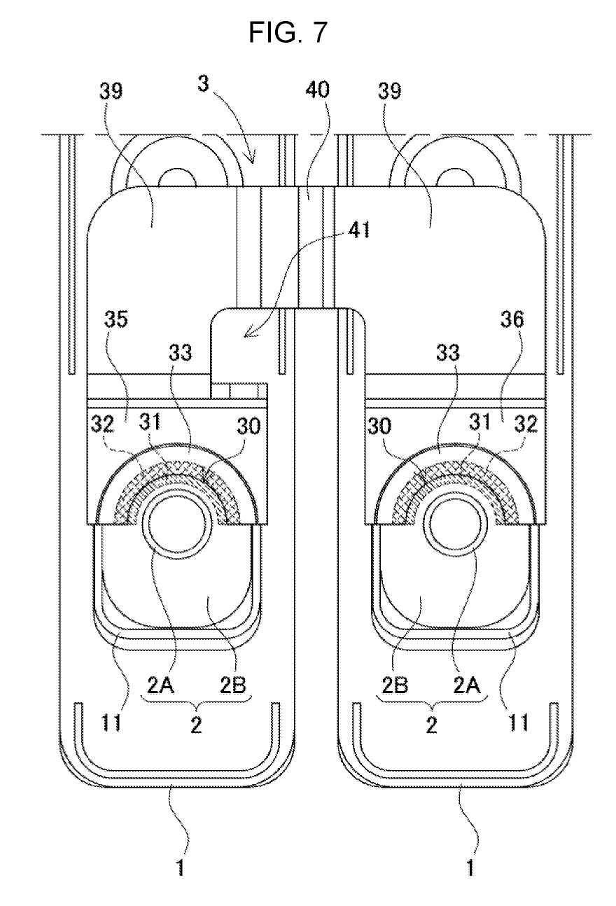

### DETAILED DESCRIPTION OF THE PREFERRED EMBODIMENT

Hereinafter, exemplary embodiments of the present invention are described with reference to the drawings. The exemplary embodiments described below are illustrations of a battery system to give a concrete form to technical ideas of the present invention. The present invention is not specifically limited to a battery system described below. Furthermore, it should be appreciated that the members shown in claims are not specifically limited to members in the exemplary embodiments.

The battery system of the present invention is used for various applications, for example, a power source installed in an electric-powered vehicle such as a hybrid car or an electric automobile to supply electric power to a driving motor, a power source for storing natural energy power generated, by for example, solar power and wind power, a power source for storing late-night electric power, or the like, and in particular, is used as a power source suitable for applications for large electric power and a large current.

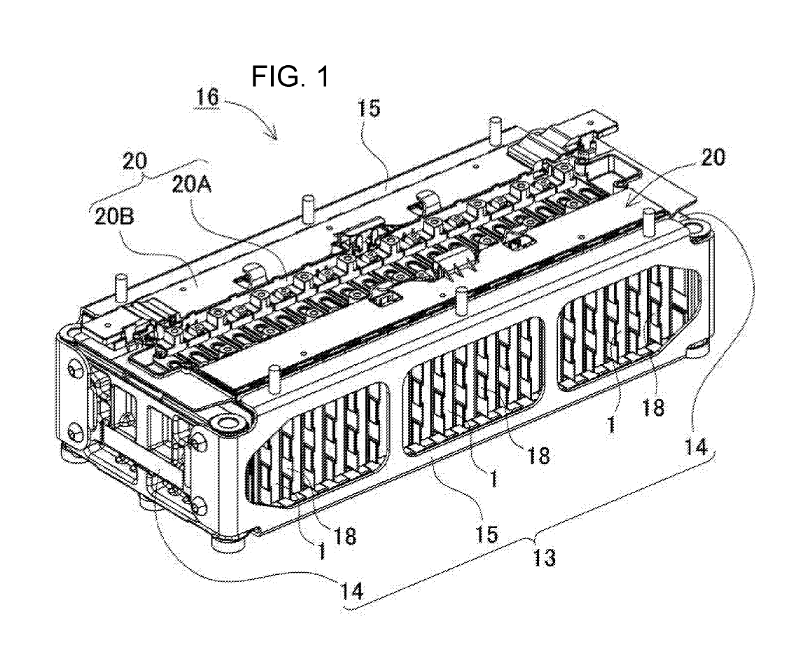

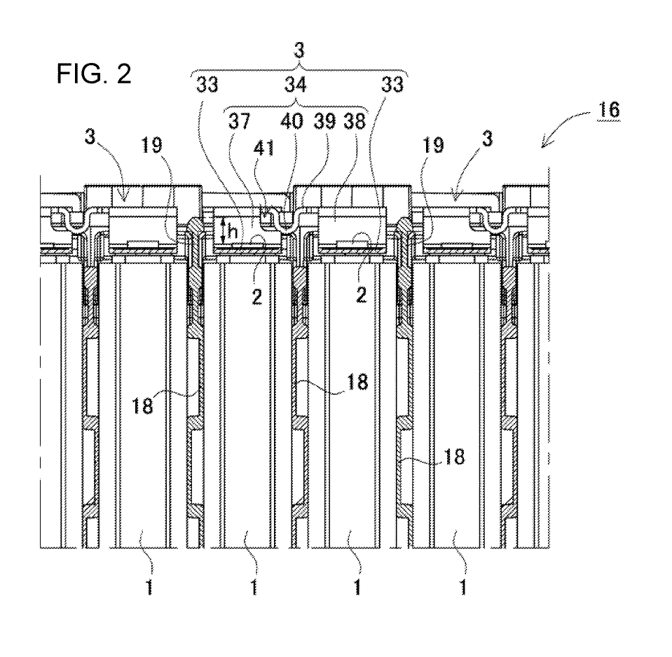

A battery system shown in FIGS. 1 and 2 includes a plurality of battery cells 1 that are fixed in a state in which battery cells 1 are stacked with insulating separators 18 sandwiched therebetween. Each battery cell 1 is a rectangular battery. Furthermore, each battery cell 1 is a rectangular battery including a lithium ion battery. However, in the battery system of the present invention, battery cell 1 is not particularly limited to a rectangular battery, and not particularly limited to lithium ion secondary battery. As the battery cell 1, any chargeable batteries, for example, nonaqueous electrolyte secondary battery cells other than lithium ion secondary battery cell, a nickel hydride battery cell can be used.

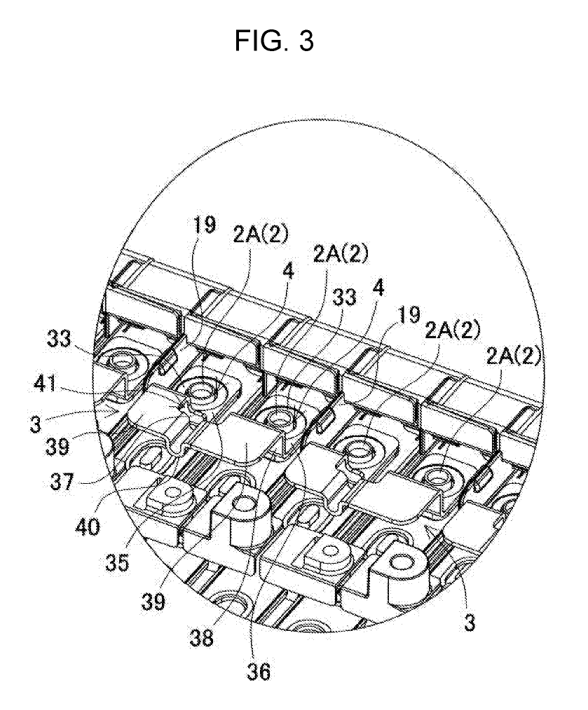

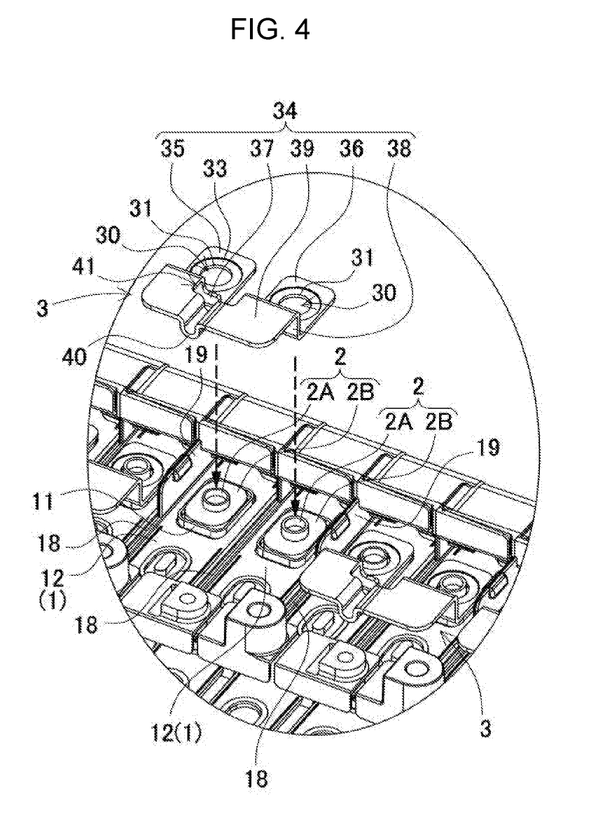

In the rectangular battery, positive and negative electrode terminals 2 are fixed to sealing plate 12 via insulating material 11 as shown in FIGS. 3 and 4. Note here that in order to easily understand a connection state between battery cell 1 and busbar 3, FIGS. 3 and 4 do not show insulating separator 18 stacked between the plurality of battery cells 1 and busbar holder 20 for disposing a plurality of busbars 3 in predetermined positions (details are described later). Positive and negative electrode terminals 2 each include protruding portion 2A and welding surface 2B provided around protruding portion 2A. Welding surface 2B is a plane in parallel to the surface of sealing plate 12. Welding surface 2B has protruding portion 2A in a middle of welding surface 2B. Electrode terminal 2 shown in the drawings has columnar protruding portion 2A. The protruding portion is not necessarily limited to a columnar-shape, and may be a polygonal or elliptic cylinder shape although not shown.

The plurality of stacked battery cells 1 are fixed to a predetermined position by fixing component 13 to form a rectangular parallelepiped battery block 16. Fixing component 13 includes a pair of end plates 14 and fastening member 15. End plates 14 are disposed at both end surfaces of stacked battery cells 1, and fastening member 15 is coupled at the end parts thereof and fixes stacked battery cells 1 in a state in which pressure is applied.

In battery block 16, battery cells 1 are stacked such that the surfaces having electrode terminals 2 of battery cells 1, that is, sealing plates 12 in the drawings are flush with each other. The battery systems of FIGS. 1 and 2 have positive and negative electrode terminals 2 on the upper surface of battery block 16. In battery block 16, battery cells 1 are stacked in a state in which the directions of the positive and negative electrode terminals 2 on both of the end parts of sealing plate 12 are opposite in the right and left directions. In battery block 16, as shown in FIGS. 3 and 4, on both of the sides of battery block 16, adjacent electrode terminals 2 are linked to each other using metal plate busbar 3 and battery cells 1 are connected in series.

In cell blocks 16, battery cells 1 are stacked such that adjacent battery cells 1 are insulated from each other with insulating separator 18 sandwiched between battery cells 1. Furthermore, cell block 16 is provided with insulating wall 19 between adjacent electrode terminals 2 having a potential difference to increase a creepage distance between adjacent electrode terminals 2 having a potential difference. In cell block 16 shown in a sectional view of FIG. 2, insulating wall 19 is unitarily molded with insulating separator 18 made of plastic to form a unitary structure with insulating separator 18. Insulating wall 19 is disposed in a predetermined position with insulating separator 18 sandwiched between battery cells 1.

Insulating wall 19 is disposed between electrode terminals 2 having a potential difference as shown in a sectional view of FIG. 2 and a perspective view of FIG. 3, and protrudes higher than electrode terminal 2 and preferably higher than the upper end of electrode terminal 2. Insulating walls 19 are disposed high and adjacent to each other, so that a creepage distance between electrode terminals 2 having a potential difference can be increased. Thus, height (h) of insulating wall 19 at a part protruding from the upper end surface of electrode terminal 2 is, for example, 5 mm or more, and preferably 8 mm or more to secure the creepage distance between electrode terminals 2 having a potential difference.

The insulating wall may be unitarily formed with busbar holder 20 (see, FIG. 1) made of plastic for disposing busbars 3 in a predetermined position. For example, in busbar holder 20, an inside of holder main body 20A disposing a plurality of busbars 3 is partitioned into a plurality of parts to form partitioned chambers. In the partitioned chambers, busbars 3 are disposed in predetermined positions, respectively. At the same time, a partitioned wall serving as a boundary of the partitioned chambers may be an insulating wall. This insulating wall is disposed between busbars 3 that are adjacent to each other, and insulates between electrode terminals 2 having a potential difference. Since in this structure, the insulating wall is unitarily formed with busbar holder 20 for disposing busbars 3 in a predetermined position, a relative position between the insulating wall and the busbar can be in an ideal state.

Since insulating wall 19 is disposed near electrode terminal 2 to which busbar 3 is laser-welded, insulating wall 19 is heated under irradiation with a laser beam. When insulating wall 19 made of plastic is heated, it is melted. Furthermore, a surface of insulating wall 19 is vaporized to generate gas. The generated gas enters welding parts of busbar 3 and electrode terminal 2, causing the welding strength to be deteriorated. In the step of laser-welding busbar 3 to electrode terminals 2, busbar 3 and electrode terminal 2 are heated to the melting temperature with a laser beam. Light and infrared rays (electromagnetic wave) are radiated from the heated parts of busbar 3 and electrode terminal 2. Radiated light is applied to the surface of insulating wall 19 that is located in the vicinity thereof. Many substances have property of absorbing light in the wavelength region of far-infrared rays, the object generates heat by irradiation with far-infrared rays. Furthermore, the object generates heat also by absorption of visible light. Insulating wall 19 is configured to have a surface having reflectance of light including visible light and infrared rays of 50% or more in order to reduce the absorbing thermal energy.

In general, infrared rays have a wavelength of 0.78 to 1000 μm. Among them, infrared rays having a wavelength of 4 to 1000 μm are called far-infrared rays. Furthermore, the visible light has a wavelength of 380 to 780 nm. The wavelength region of the infrared rays and the wavelength region of the visible light are continuous. Substances having high reflectance of visible light (the light having a wavelength of 380 to 780 nm) tend to have also high reflectance of infrared rays. Therefore, insulating wall 19 has a heat-ray reflecting color having visible light reflectance of 50% or more. Such substances can be formed of polyester plastic materials such as PBT (polybutylene terephthalate), PP (polypropylene), PA (polyamide/nylon (registered trademark)), and the like. Alternatively, composite materials of these resins and glass fiber, glass beads, and the like, can be used. Insulating wall 19 having this configuration can reduce generation of thermal energy due to absorption of light as mentioned above. Note here that when insulating wall 19 is coated with an infrared ray reflecting coating material having property of reflecting infrared rays, it is possible to suppress heat generation due to absorption of light by insulating wall 19.

As mentioned above, at the time of laser welding, light (electromagnetic wave) is radiated. Examples of laser used at the time of laser welding include fiber laser (wavelength: for example, 1060 to 1070 nm), disk laser (wavelength: for example, 1030 nm), semiconductor laser (wavelength: for example, 808, 825, 880, and 975 nm), YAG laser wavelength: for example, 1064 nm), and the like. When laser welding is carried out using such laser, since visible light and infrared ray are mainly radiated, insulating wall 19 can be expected to suppress heat generation of insulating wall 19 due to absorption of light by increasing visible light reflectance and infrared reflectance. In particular, among the radiated light, the far-infrared ray has a remarkably high effect of applying heat to an object, and it is preferable that insulating wall 19 has far-infrared reflectance of 50% or more. Insulating wall 19 reflects not less than half of the irradiated far-infrared rays, so that an absorption amount of heat-rays can be reduced. Furthermore, in insulating wall 19, a surface color has reflectance of visible light or infrared rays of preferably 60% or more and further preferably 70% or more, and furthermore, the absorption amount of heat-rays can be effectively reduced and generation of gas can be effectively inhibited.

The surface of insulating wall 19 can have a heat-ray reflecting color by molding plastic whose body color is a heat-ray reflecting color. Furthermore, insulating wall 19 can have a body color that is a heat-ray reflecting color by filling plastic with powdery filler. Insulating wall 19 can molded to have a body color that is a heat-ray reflecting color by adding inorganic powder of, for example, silica, calcium carbonate, magnesium carbonate, and alumina, having a white body color as a filler to plastic, and mixing thereof. Insulating wall 19 produced by molding plastic whose body color that is a heat-ray reflecting color can be mass-produced at a low cost. After molding plastic, insulating wall 19 can have a surface having a heat-ray reflecting color by coating the surface of insulating wall 19 with coating material having a heat-ray reflecting color.

Busbar 3 is welded to positive and negative electrode terminals 2 at both end portions thereof, and connects battery cells 1 in series. In the battery system, battery cells 1 are connected in series to increase an output voltage. Busbar 3 can connect battery cells 1 in series and in parallel. This battery system can increase an output voltage and an output electrical current.

Busbar 3 is provided with cut-away portion 30 for guiding protruding portion 2A of electrode terminal 2. Busbar 3 of FIGS. 3 and 4 is provided with cut-away portions 30 at both end portions thereof. Protruding portions 2A of electrode terminals 2 of adjacent battery cells 1 are guided to cut-away portions 30, respectively. In busbars 3 of FIGS. 3 and 4, cut-away portion 30 is a through-hole, and protruding portion 2A is inserted into the inside thereof. Cut-away portion 30 has an inner shape capable of guiding protruding portion 2A of electrode terminal 2. Furthermore, cut-away portion 30 is provided with exposure gap 4 between the inner edge and protruding portion 2A in a state in which protruding portion 2A is guided, in order to expose welding surface 2B of electrode terminal 2 in a state in which protruding portion 2A is guided to cut-away portion 30.

In cut-away portion 30 having exposure gap 4, to the inner side thereof, protruding portion 2A is not closely attached. The inner edge of cut-away portion 30 is irradiated with a laser beam so as to melt the inner edge, and welding surface 2B of electrode terminal 2 can be welded reliably. Consequently, welding to welding surface 2B of electrode terminal 2 can be carried out reliably with the inner edge of cut-away portion 30 as fillet weld part 31. Furthermore, in a step of laser-welding busbar 3 to electrode terminals 2, a laser beam or a position-detection sensor is inserted into exposure gap 4, so that a position of welding surface 2B can be detected. When the position of welding surface 2B can be detected, a position of the surface of busbar 3 can be detected by the laser beam or the position-detection sensor, so that it is possible to determine whether busbar 3 is attached closely to welding surface 2B. In a step of laser-welding busbar 3 to electrode terminal 2, when there is a gap between busbar 3 and welding surface 2B, reliable laser welding cannot be secured. The position of welding surface 2B is detected and further the position of busbar 3 is detected, so that an interval between busbar 3 and welding surface 2B can be detected. In the laser welding step, when it is detected that busbar 3 is closely attached to welding surface 2B and laser welding is carried out, busbar 3 can be reliably laser-welded to welding surface 2B. When there is a gap between busbar 3 and welding surface 2B, laser welding is stopped, and busbar 3 is pressed to be closely attached to welding surface 2B, or busbar 3 is exchanged and closely attached to welding surface 2B. Thus, laser-welded busbar 3 can be welded to electrode terminal 2 reliably.

Exposure gap 4 is preferably more than 1 mm, and more preferably 2 mm or more. Exposure gap 4 having this interval makes it possible to irradiate welding surface 2B with a laser beam, or to insert the position-detection sensor to reliably detect the position of welding surface 2B. Furthermore, the inner edge of cut-away portion 30 can be irradiated with a laser beam and fillet weld part 31 can be laser-welded to welding surface 2B reliably.

Busbar 3 of FIGS. 3 and 4 has cut-away portion 30 as a through-hole. Furthermore, the through-hole is formed in a circular shape whose inner shape is made larger than the outer shape of protruding portion 2A, and exposure gap 4 is provided between busbar 3 and protruding portion 2A. In a link structure in which columnar protruding portion 2A is inserted into cut-away portion 30 as a circular through-hole, the inner edge of the through-hole is welded to welding surface 2B by fillet weld part 31, as shown in FIG. 4, busbar 3 can be reliably welded to welding surface 2B by fillet weld part 31 and penetration weld part 32 by irradiation with a focused laser beam in a circular locus.

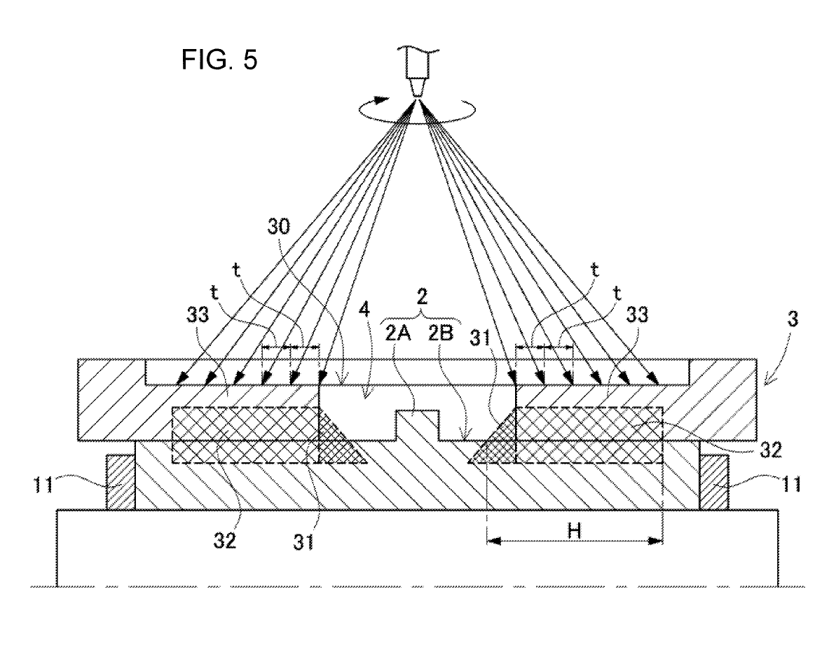

As shown in FIG. 5, busbar 3 is welded to welding surface 2B by fillet weld part 31 that welds the inner edge of cut-away portion 30 to welding surface 2B and by penetration weld part 32 that welds the boundary with respect to welding surface 2B of electrode terminal 2. Busbar 3 is welded to welding surface 2B in a predetermined welding width (H) by fillet weld part 31 and penetration weld part 32. In order to weld busbar 3 to electrode terminals 2 with sufficient strength, the welding width (H) is, for example, 0.8 mm or more, preferably 1 mm or more, and further preferably 1.2 mm or more. When the welding width (H) is increased, the welding strength can be increased, but it takes a long time to carry out welding. Therefore, the welding width (H) is, for example, 5 mm or less, preferably 4 mm or less, and further preferably 3 mm or less.

Busbar 3 is welded to welding surface 2B of electrode terminal 2 in a predetermined welding width (H) by fillet weld part 31 and penetration weld part 32 by irradiation with a laser beam, focused on a predetermined radius, at a predetermined pitch (t) in a plurality of lines. Busbar 3 is welded to welding surface 2B by fillet weld part 31 by irradiation with a laser beam applied in a plurality of lines along the inner edge of cut-away portion 30. Thereafter, irradiation is carried out by displacing the irradiation positions of laser beam at a predetermined pitch (t), and busbar 3 is welded to welding surface 2B by penetration weld part 32. The laser beam, which is irradiated in a plurality of lines and with which busbar 3 is welded to welding surface 2B by fillet weld part 31 and penetration weld part 32, is focused on a narrow area, and the busbar 3 is irradiated with the focused laser beam. The focused laser beam is focused on an area that is substantially equal to or larger than the pitch (t) of irradiation carried out in the plurality of lines. The laser beam which is focused on an area larger than the pitch (t) is irradiated in a plurality of lines, so that busbar 3 can be welded uniformly welded to welding surface 2B in a predetermined welding width (H).

The laser beam irradiated at a predetermined pitch (t) in a plurality of lines is irradiated, for example, in three lines or more, preferably in five lines or more, and more preferably ten lines or more, so that busbar 3 can be reliably welded to welding surface 2B by fillet weld part 31 and penetration weld part 32. With a welding structure in which busbar 3 is welded by fillet weld part 31 and penetration weld part 32 by irradiation with a laser beam at a predetermined pitch (t) in a plurality of lines, busbar 3 can be welded to welding surface 2B reliably. Also, by increasing an area into which a laser beam is converged, busbar 3 can be welded to welding surface 2B by both fillet weld part 31 and penetration weld part 32. This laser beam is adjusted to energy capable of reliably welding busbar 3 to welding surface 2B by fillet weld part 31 and penetration weld part 32.

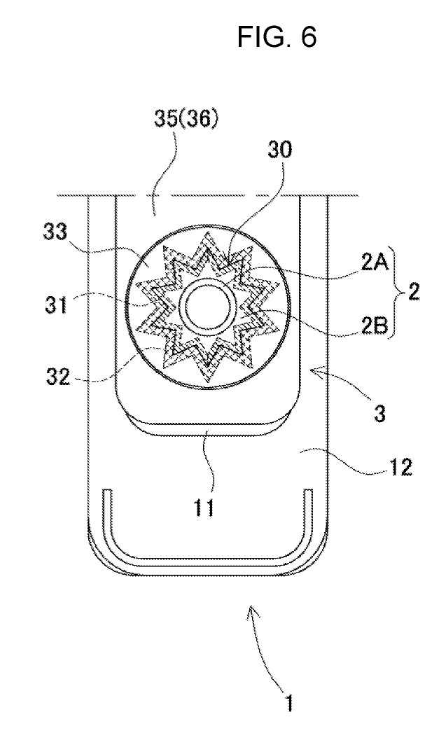

Busbar 3 of FIG. 6 has cut-away portion 30 as a star-shaped through-hole, and the inner edge of the through-hole is welded to welding surface 2B by fillet weld part 31 and the outer side is welded to welding surface 2B as penetration weld part 32. This welding structure enables busbar 3 to be fixed to welding surface 2B strongly. Furthermore, busbar 3 of FIG. 6 has cut-away portion 30 as a concave or recess portion, and the inner edge of the recess portion is welded to welding surface 2B by fillet weld part 31, and the outer side of fillet weld part 31 is welded to welding surface 2B as penetration weld part 32.

Busbars 3 are disposed in the predetermined positions by busbar holder 20 shown in FIG. 1. Protruding portions 2A of electrode terminals 2 are guided to cut-away portions 30. Busbar holder 20 is molded by an insulating material such as plastic, and disposes busbars 3 in the predetermined positions by fitting structures. Busbar holder 20 is linked to battery block 16, and disposes busbars 3 to the predetermined positions. Busbar holder 20 is linked to insulating separators 18 stacked between rectangular batteries and disposed to the predetermined positions, or linked to the rectangular batteries and linked to the predetermined positions of battery block 16. Busbar holder 20 shown in FIG. 1 is provided with frame-shaped holder main body 20A for disposing a plurality of busbars 3 to the predetermined positions and cover plate 20B for closing the upper opening of holder main body 20A. Holder main body 20A is disposed in the upper surface of battery block 16 in a state in which a plurality of busbars 3 are fixed to the predetermined positions, and cut-away portion 30 of each busbar 3 is disposed to protruding portion 2A of electrode terminal 2. Furthermore, in this state, busbars 3 are weld-joined to electrode terminals 2 by irradiation with a laser beam from the upper opening of holder main body 20A. After all busbars 3 are weld-joined to electrode terminals 2, the upper opening of holder main body 20A is covered with the cover plate 20B.

Busbar 3 of FIGS. 3 and 4 includes a pair of welding plate portions 33 welded and coupled to electrode terminals 2, and linking portion 34 linking the pair of welding plate portions 33. A thickness of linking portion 34 is larger than that of welding plate portion 33. Busbar 3 of FIG. 4 is provided with welding plate portion 33 in the vicinity of cut-away portion 30 and in a part that is laser-welded to welding surface 2B by fillet weld part 31 and penetration weld part 32. In busbar 3 of FIG. 3, cut-away portion 30 is a circular through-hole, and, therefore, circular welding plate portion 33 is provided in the vicinity of the through-hole. Since welding plate portion 33 is laser-welded to welding surface 2B, it has larger width than welding width (H) at which it is welded to welding surface 2B by fillet weld part 31 and penetration weld part 32.

Welding plate portion 33 has a thickness that can be reliably laser-welded to welding surface 2B of electrode terminal 2. A thickness of welding plate portion 33 is set at a dimension that enables reliable welding both fillet weld part 31 and penetration weld part 32 to be welded to welding surface 2B with a laser beam irradiated to the surface of welding plate portion 33 as shown in the sectional view of FIG. 5. The thickness of welding plate portion 33 is, for example, 0.3 mm or more, and preferably 0.4 mm or more. When the thickness is too large, it is necessary to increase energy for laser-welding penetration weld part 32 to welding surface 2B. Therefore, the thickness of welding plate portion 33 is set at, for example, 2 mm or less, and preferably 1.6 mm or less.

Linking portion 34 of busbar 3 of FIGS. 3 and 4 includes first connection portion 35 and second connection portion 36 provided at both end parts; first rising portion 37 and second rising portion 38 coupled to first connection portion 35 and second connection portion 36 via bent portions, respectively; and middle linking portion 39 coupled to first rising portion 37 and second rising portion 38 via bent portions, respectively. First connection portion 35 and second connection portion 36 are provided with welding plate portion 33 at the inner side. First rising portion 37 and second rising portion 38 are coupled to first connection portion 35 and second connection portion 36 and disposed in a vertical orientation via bent portions bent at a right angle, with a predetermined radius of curvature. Middle linking portion 39 is coupled to first rising portion 37 and second rising portion 38 and disposed in a horizontal orientation via a bent portion that is bent at a right angle, with a predetermined radius of curvature. Middle linking portion 39 is provided with U-curved portion 40 in the middle portion thereof. In middle linking portion 39, the width of U-curved portion 40 is narrower than the width of first connection portion 35 and second connection portion 36 and made to be easily deformed. Busbar 3 of FIG. 3 is provided with cut-away recess portion 41 in the vicinity of the bent portion that links first rising portion 37 and middle linking portion 39, and the width of U-curved portion 40 is made to be narrower. This busbar 3 is formed by linking two metals having different electrical resistance, and is provided with cut-away recess portion 41 in a bent portion made of metal having smaller electrical resistance, to prevent the electrical resistance from being increased by cut-away recess portion 41. For example, in busbar 3 in which first connection portion 35, first rising portion 37 and one end of middle linking portion 39 are formed of a copper plate, and second connection portion 36, second rising portion 38 and the other end of middle linking portion 39 are formed of an aluminum plate, a cut-away recess portion is provided in the vicinity of the bent portion as the copper plate, and the width of U-curved portion 40 can be reduced and easily deformed while increase in the electrical resistance of busbar 3 is reduced. The above-mentioned busbar is configured of the aluminum plate and the copper plate, but it may be formed of only an aluminum plate or only a copper plate.

In the above-mentioned battery system, electrode terminals 2 are connected to busbar 3 by the following steps.

(1) Busbar holder 20 in which a plurality of busbars 3 are arranged in the predetermined positions is disposed in the predetermined position of battery block 16. Protruding portion 2A of electrode terminal 2 is guided to cut-away portion 30 of busbar 3.

(2) Welding surface 2B is irradiated with a laser beam from exposure gap 4 so as to detect the position of welding surface 2B, and further the surface of busbar 3 is irradiated with a laser beam so as to detect the position of busbar 3, for determining whether or not busbar 3 is brought into contact with welding surface 2B. When it is determined that busbar 3 is in contact with welding surface 2B, the step proceeds to the next step.

When busbar 3 is apart from welding surface 2B by a set value, an error message is displayed. When the error message is displayed, busbar 3 is exchanged or a position of busbar 3 is adjusted, so that busbar 3 is brought into contact with welding surface 2B.

(3) A position of the inner edge of cut-away portion 30 of busbar 3 is pattern-recognized in a state in which busbar 3 is brought into contact with welding surface 2B; the inner edge of cut-away portion 30 is irradiated with a laser beam; the inner edge of cut-away portion 30 as fillet weld part 31 is laser-welded; a position that is apart from fillet weld part 31 at a predetermined pitch is irradiated with a plurality of lines of laser beams along fillet weld part 31; busbar 3 is welded to welding surface 2B in a predetermined width, and welded as penetration weld part 32. As shown in FIG. 3, busbar 3 having cut-away portion 30 as a circular through-hole is irradiated with a laser beam along the inner diameter of the through-hole as shown in FIG. 4, is welded to welding surface 2B using the inner edge of the through-hole as fillet weld part 31, and then irradiated with a laser beam and welded to welding surface 2B as penetration weld part 32 while a radius irradiated with a laser beam at the predetermined pitch is increased. Welding portions of fillet weld part 31 and penetration weld part 32 are continuous. Welding plate portion 33 of busbar 3 is welded to welding surface 2B by fillet weld part 31 and the penetration weld part 32 in a predetermined width.

A laser beam heats and melts busbar 3 and welding surface 2B. In this state, the irradiation region of the laser beam is heated to such a high temperature at which metal busbar 3 and welding surface 2B are melted. The irradiation region that has been heated to a high temperature radiates far-infrared rays to the surrounding. Insulating wall 19 is irradiated with the radiated far-infrared rays and heated. Insulating wall 19 has far-infrared reflectance of 50% or more, and reflects not less than half of the far-infrared ray. In insulating wall 19 having a surface that reflects the far-infrared ray, a temperature at which insulating wall 19 is heated by absorbing irradiated far-infrared rays is low. The surface is not vaporized by thermal energy of the irradiated far-infrared rays.

In an insulating wall having a surface whose far-infrared reflectance is 10%, in the step of laser-welding the busbar, the insulating wall made of plastic is heated, vaporized, and generates such a large amount gas that a welding part cannot be recognized. The gas enters the welding portions of the busbar and the electrode terminal, and weld-joining strength is deteriorated. On the contrary, in insulating wall 19 in which white inorganic powder of plastic is mixed into plastic and the surface color is a heat-ray reflecting color having far-infrared reflectance of 70%, gas is not generated due to heating in the welding step of busbar 3, thus preventing deterioration of the weld-joining strength due to contamination of gas into the welding portion. Furthermore, also in insulating wall 19 whose surface is coated with milk-white infrared ray reflecting coating material having reflectance of light including visible light and infrared rays of 50%, generation of gas due to heating in the welding step of busbar 3 is very small, and deterioration of the weld-joining strength due to contamination of gas into the welding portion is prevented.

In busbar 3 of FIG. 4, since cut-away portion 30 is a circular through-hole, both fillet weld part 31 and penetration weld part 32 are formed in a ring shape. However, as shown in FIG. 6, in busbar 3 having semicircular cut-away portion 30, fillet weld part 31 and penetration weld part 32 are formed in a semicircular-shape, and welding plate portion 33 of busbar 3 is welded to welding surface 2B in a predetermined width.

### INDUSTRIAL APPLICABILITY

In a battery system of the present invention, electrode terminals of battery cells and a busbar are electrically connected reliably and stably. Thereby, the battery system can be suitably used for power sources of electric-powered vehicles or power sources for storing natural energy or late-night power.

### REFERENCE MARKS IN THE DRAWINGS

1 . . . battery cell
2 . . . electrode terminal
2A . . . protruding portion
2B . . . welding surface
3 . . . busbar
4 . . . exposure gap
11 . . . insulating material
12 . . . sealing plate
13 . . . fixing component
14 . . . end plate
15 . . . fastening member
16 . . . battery block
18 . . . insulating separator
19 . . . insulating wall
20 . . . busbar holder
20A . . . holder main body
20B . . . cover plate
30 . . . cut-away portion
31 . . . fillet weld part
32 . . . penetration weld part
33 . . . welding plate portion
34 . . . linking portion
35 . . . first connection portion
36 . . . second connection portion
37 . . . first rising portion
38 . . . second rising portion
39 . . . middle linking portion
40 . . . U-curved portion
41 . . . cut-away recess portion

1. A battery system comprising:
a plurality of battery cells;
a busbar that is laser-welded to electrode terminals of adjacent ones of the battery cells and electrically connects the battery cells; and
an insulating wall made of plastic and disposed between the adjacent ones of the electrode terminals,
wherein the insulating wall has a surface color that is a heat-ray reflecting color having reflectance of at least visible light of 50% or more.

2. The battery system according to claim 1, wherein the insulating wall is formed of a resin having the heat-ray reflecting color.

3. The battery system according to claim 1, wherein the insulating wall includes a filler having the heat-ray reflecting color.

4. The battery system according to claim 1, wherein the insulating wall further has infrared reflectance of 50% or more.

5. The battery system according to claim 4, wherein the insulating wall has a surface coated with a coating material that reflects at least one of visible light and infrared rays.

6. The battery system according to claim 1, wherein the battery cells are rectangular batteries, and a plastic insulating separator stacked between the rectangular batteries is formed unitarily with the insulating wall.

7. The battery system according to claim 1, wherein the insulating wall is formed unitarily with a busbar holder made of plastic for disposing the busbar in a predetermined position.
